(19) United States
(12) Patent Application Publication
(10) Pub. No.: US 2007/0208872 A1
(43) Pub. Date: Sep. 6, 2007

(54) SYSTEM AND METHOD FOR PROCESSING STREAMING DATA

(75) Inventor: Shu-Min Cheng, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,939

(22) Filed: May 29, 2006

(30) Foreign Application Priority Data
Mar. 3, 2006 (TW) 095107221

(51) Int. Cl. G06F 15/16

(52) U.S. Cl. 709/231

(57) ABSTRACT

A streaming data processing system used in a client connected to a streaming server is provided, the streaming data processing system including: a recording module, a reading module, a frame determining module, and a reformatting module. The recording module is for receiving streaming data from the streaming server, and for recording the streaming data as a streaming file. The reading module is for reading packets of the streaming file, and for determining the number of the packets. The frame determining module is for sequentially determining whether one of the packets is a key frame. The reformatting module is for acquiring the number of the packets determined by the reading module, and for reformatting the key frame and all packets thereafter. A streaming data processing method is also provided.

### FIELD OF THE INVENTION

The invention relates to a system and method for processing data, and more particularly to a system and method for processing multimedia data.

### DESCRIPTION OF RELATED ART

Nowadays, set top boxes are widely used in multimedia services, and many people enjoy multimedia programs in the format of advanced stream format (ASF) via the set top box.

ASF is a streaming format developed by Microsoft. An ASF file integrates picture, sound, and animation, and file size thereof is much smaller in comparison with other types of multimedia files, which make the ASF file fit for being transmitted through the Internet.

In addition to enjoying ASF-formatted streaming programs, users often desire to record programs as well. However, since the number of multimedia files that are supported by the set top box is limited, the users may not play ASF files that are partly recorded, and have to wait until the end of a recording process.

### SUMMARY OF THE INVENTION

A streaming data processing system used in a client connected to a streaming server is provided, the streaming data processing system including: a recording module, a reading module, a frame determining module, and a reformatting module. The recording module is for receiving streaming data from the streaming server, and for recording the streaming data as a streaming file. The reading module is for reading packets of the streaming file, and for determining the number of the packets. The frame determining module is for sequentially determining whether one of the packets is a key frame. The reformatting module is for acquiring the number of the packets determined by the reading module, and for reformatting the key frame and all packets thereafter.

A streaming data processing method used in a client connected to a streaming server is also provided, the streaming data processing method including steps of: receiving streaming data from the streaming server and recording the streaming data as a streaming file; reading packets of the streaming data and determining the number of the packets; sequentially determining whether one of the packets is a key frame; reformatting the key frame and all packets thereafter if the packet is the key frame; and discarding the packet and inquiring the next packet if the packet is not the key frame.

Other advantages and novel features will become more apparent from the following detailed description when taken in conjunction with the accompanying drawings, in which:

### BRIEF DESCRIPTION OF THE DRAWINGS

FIG. 1 is a schematic diagram illustrating an application environment of a streaming data processing system in accordance with an exemplary embodiment of the invention;

FIG. 2 is a block diagram of the streaming data processing system in accordance with another exemplary embodiment of the invention;

FIG. 3 is a flow chart of a streaming data processing method in accordance with a further exemplary embodiment of the invention;

FIG. 4 is a detailed flow chart of receiving streaming data from a streaming server and recording the streaming data as a streaming file; and

FIG. 5 is a detailed flow chart of reformatting a key frame and all packets thereafter.

### DETAILED DESCRIPTION OF THE INVENTION

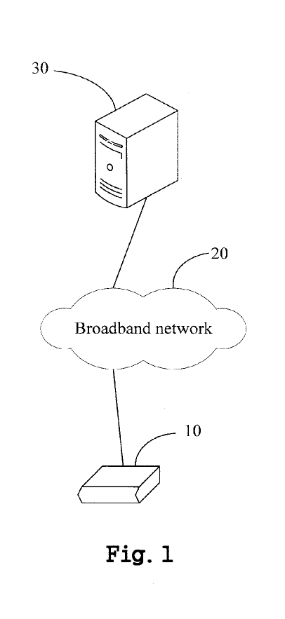

FIG. 1 is a schematic diagram illustrating an application environment of a streaming data processing system 100 in accordance with an exemplary embodiment of the invention. A client 10 is connected with a streaming server 30 through a broadband network 20. In this embodiment, the client 10 is a set top box.

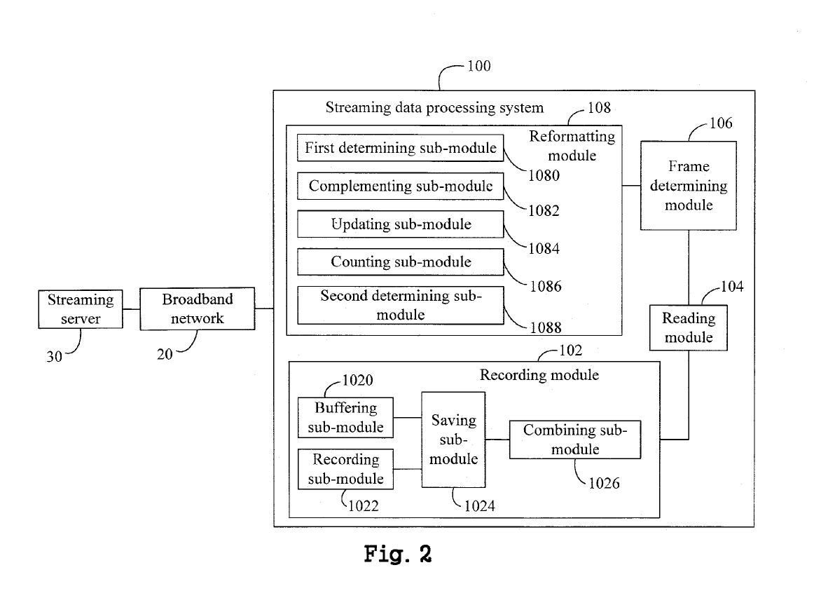

FIG. 2 is a block diagram of the streaming data processing system 100 in accordance with another exemplary embodiment of the invention. The streaming data processing system 100 is arranged in the client 10 (not shown).

The streaming data processing system 100 includes a recording module 102, a reading module 104, a frame determining module 106, and a reformatting module 108. The recording module 102 is for receiving streaming data from the streaming server 30 and recording the streaming data as a streaming file. In this embodiment, both the streaming data and the streaming file are in the format of advanced streaming format (ASF). The recording module 102 includes a buffering sub-module 1020, a recording sub-module 1022, a saving sub-module 1024, and a combining sub-module 1026.

The buffering sub-module 1020 is for buffering the streaming data from the streaming server 30 before the client 10 starts recording. In this embodiment, since a time interval exists between transmission and recording of the streaming data, and the streaming server 30 keeps transmitting the streaming data during the time interval, the buffering sub-module 1020 must continue to receive and buffer the streaming data transferred during the time interval. The recording sub-module 1022 is for recording the streaming data from the streaming server 30. The saving sub-module 1024 is for respectively saving streaming data buffered by the buffering sub-module 1020 and streaming data recorded by the recording sub-module 1022 as a buffered streaming file and a real-time streaming file. The combining sub-module 1026 is for combining the buffered streaming file with the real-time streaming file to produce a streaming file.

The reading module 104 is for reading packets of the streaming file and determining the number of the packets. In this embodiment, each packet includes a header field and a payload field, and the header field further includes information relating to a payload length.

The frame determining module 106 is for sequentially determining whether one of the packets is a key frame. In this embodiment, the key frame is an uncompressed frame, and the streaming file can be played only if the key frame is the first packet of the streaming file.

The reformatting module 108 is for acquiring the number of the packets determined by the reading module 104, and reformatting a packet being the key frame and all packets thereafter. The reformatting module 108 includes a first determining sub-module 1080, a complementing sub-module 1082, an updating sub-module 1084, a counting sub-module 1086, and a second determining sub-module 1088.

The first determining sub-module 1080 is for determining whether the payload length of one of the packets is less than a predetermined length. In this embodiment, the streaming server 30 presets the predetermined length in the first determining sub-module 1080.

The complementing sub-module 1082 is for complementing the payload field with a null bit. In this embodiment, the complementing sub-module 1082 adds the null bit to the end of the packet if the payload length is less than the predetermined length.

The updating sub-module 1084 is for updating the information relating to the payload length in the header field, and discarding all packets before the key frame.

The counting sub-module 1086 is for counting the number of the packets that have been determined by the first determining sub-module 1080. In this embodiment, an initial value of the counting sub-module 1086 is 0. After the first determining sub-module 1080 determines the first packet, the second packet, the third packet, . . . , the value is correspondingly changed to 1, 2, 3, . . . .

The second determining sub-module 1088 is for determining the number of the packets counted by the counting sub-module 1086 is equal to the number of the packets determined by the reading module 104. In this embodiment, if the number of the packets counted by the counting sub-module 1086 is equal to the number of the packets determined by the reading module 104, that indicates all the packets of the streaming data have been processed, and the streaming file may be played.

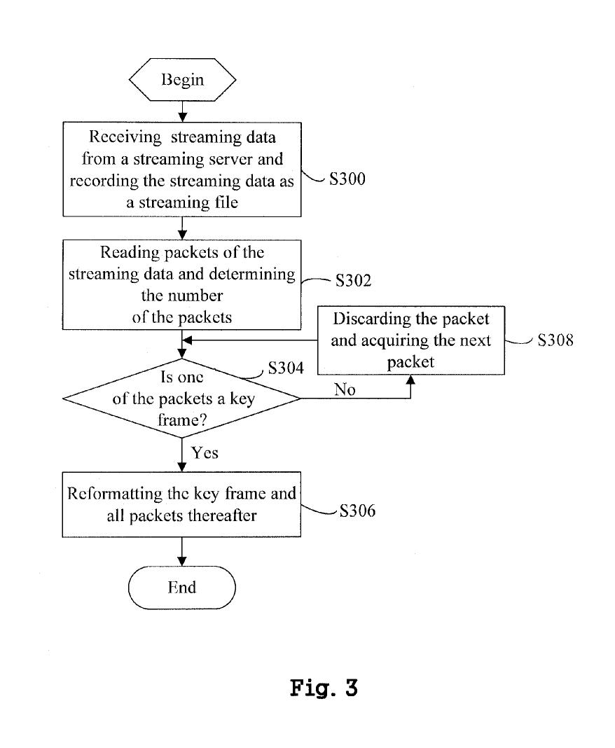

FIG. 3 is a flow chart of a streaming data processing method in accordance with a further exemplary embodiment of the invention.

In step S300, the recording module 102 receives the streaming data from the streaming server 30 and records the streaming data as a streaming file. In step S302, the reading module 104 reads the packets of the streaming data and determines the number of the packets. In step S304, the frame determining module 106 sequentially determines whether one of the packets is the key frame. If one of the packets is the key frame, the process proceeds to step S306, where the reformatting module 108 reformats the packet being the key frame and all the packets thereafter. If one of the packets is not the key frame, the process proceeds to step S308, where the updating sub-module 1084 discards the packet and inquires the next packet. The process then returns to step S304.

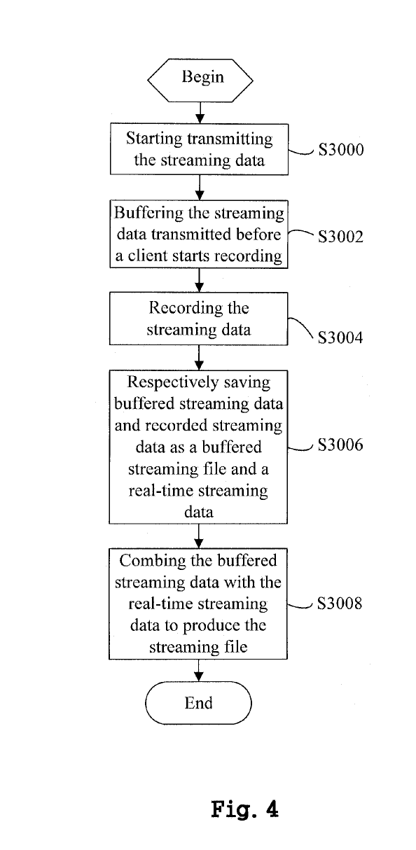

FIG. 4 is a detailed flow chart of receiving the streaming data from the streaming server 30 and recording the streaming data as the streaming file. In step S3000, the streaming server 30 starts transmitting the streaming data. In step S3002, the buffering sub-module 1020 buffers the streaming data received from the streaming server 30 before the client 10 starts recording. In step S3004, the recording sub-module 1022 records the streaming data from the streaming server 30. In step S3006, the saving sub-module 1024 respectively saves streaming data buffered by the buffering sub-module 1020 and streaming data recorded by the recording sub-module 1022 as a buffered streaming file and a real-time streaming file. In step S3008, the combining sub-module 1026 combines the buffered streaming file with the real-time streaming file to produce a streaming file.

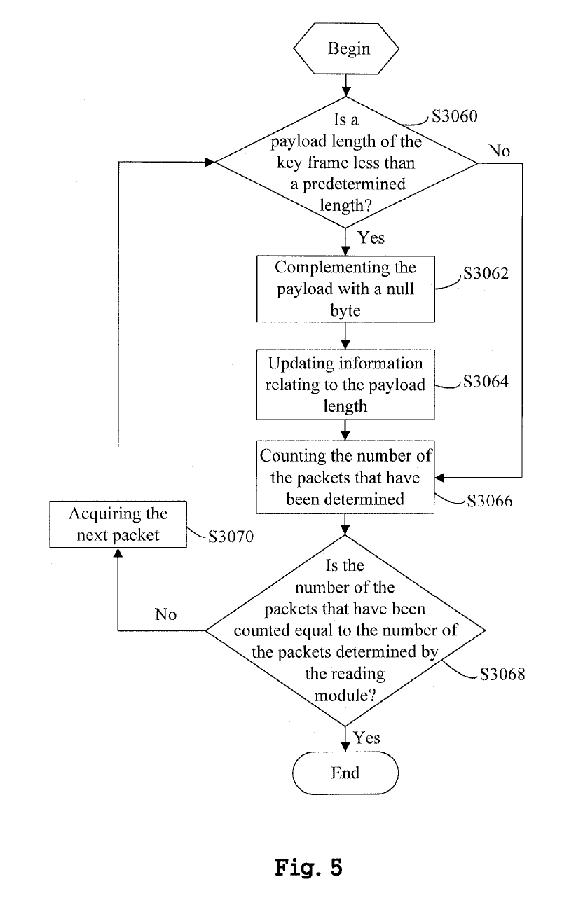

FIG. 5 is a detailed flow chart of reformatting the packet being the key frame and all packets thereafter. In step S3060, the first determining sub-module 1080 sequentially checks the packets to determine whether the payload length of one of the packets is less than the predetermined length. If the payload length is not less than the predetermined length, the process proceeds to S3066 described below. If the payload length is less than the predetermined length, the process proceeds to step S3062, where the complementing sub-module 1082 complements the payload field with the null bit. In step S3064, the updating sub-module 1084 updates the information relating to the payload length in the header field. In step S3066, the counting sub-module 1086 counts the number of the packets that have been determined by the first determining sub-module 1080. In step S3068, the second determining sub-module 1088 determines whether the number of the packets counted by the counting sub-module 1086 is equal to the number of the packets determined by the reading module 104. If the number of the packets counted by the counting sub-module 1086 is equal to the number of the packets determined by the reading module 104, the process proceeds to step S3070, where the first determining sub-module 1080 inquires the next packet. The process then returns to step S3060.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A streaming data processing system used in a client connected to a streaming server, the streaming data processing system comprising:
a recording module for receiving streaming data from the streaming server, and for recording the streaming data as a streaming file;
a reading module for reading packets of the streaming file, and for determining the number of the packets;
a frame determining module for sequentially determining whether one of the packets is a key frame; and
a reformatting module for acquiring the number of the packets determined by the reading module, and for reformatting the key frame and all packets thereafter.

2. The streaming data processing system as recited in claim 1, wherein the recording module comprises a buffering sub-module for buffering the streaming data before the client starts recording.

3. The streaming data processing system as recited in claim 2, wherein the recording module further comprises a recording sub-module for recording the streaming data.

4. The streaming data processing system as recited in claim 3, wherein the recording module further comprises a saving sub-module for respectively saving streaming data buffered by the buffering sub-module and streaming data recorded by the recording sub-module as a buffered streaming file and a real-time streaming file.

5. The streaming data processing system as recited in claim 4, wherein the recording module further comprises a combining sub-module for combining the buffered streaming data with the real-time streaming data to produce a streaming file.

6. The streaming data processing system as recited in claim 5, wherein the buffered streaming file and the real-time streaming file are in format of advanced streaming file (ASF).

7. The streaming data processing system as recited in claim 1, wherein the packet comprises a header field and a payload field.

8. The streaming data processing system as recited in claim 7, wherein the reformatting module comprises:
a first determining sub-module for sequentially determining whether a payload length is less than a predetermined length; and
a complementing sub-module for complementing the payload field with a null bit.

9. The streaming data processing system as recited in claim 8, wherein the reformatting module further comprises a updating sub-module for updating information relating to the payload length in the header field.

10. The streaming data processing system as recited in claim 9, wherein the reformatting module further comprises a counting sub-module for counting the number of the packets that have been determined by the first determining sub-module.

11. The streaming data processing system as recited in claim 10, wherein the reformatting module further comprises a second determining sub-module for determining whether the number of the packets counted by the counting sub-module is equal to the number of the packets determined by the reading module.

12. A streaming data processing method used in a client connected to a streaming server, the streaming data processing method comprising steps of:
receiving streaming data from the streaming server and recording the streaming data as a streaming file;
reading packets of the streaming data and determining the number of the packets;
determining whether one of the packets is a key frame; and
reformatting the key frame and all packets thereafter if one of the packet is the key frame.

13. The streaming data processing method as recited in claim 12, wherein the step of reading packets of the streaming data and determining the number of the packets comprises buffering the streaming data before the client starts recording.

14. The streaming data processing method as recited in claim 13, wherein the step of reading packets of the streaming data and determining the number of the packets further comprises recording the streaming data.

15. The streaming data processing method as recited in claim 14, wherein the step of reading packets of the streaming data and determining the number of the packets further comprises respectively saving a buffered streaming data and a recorded streaming data as a buffered streaming file and a real-time streaming file.

16. The streaming data processing method as recited in claim 15, wherein the step of reading packets of the streaming data and determining the number of the packets further comprises combining the buffered streaming data with the real-time streaming data to produce a streaming file.

17. The streaming data processing method as recited in claim 12, wherein determining whether one of the packets is a key frame is in the form of sequence.

18. The streaming data processing method as recited in claim 12, wherein the step of reformatting the key frame and all packets thereafter comprises:
sequentially determining whether a payload length of the packet is less than a predetermined length; and
complementing the payload field with a null bit if the payload length is less than the predetermined length.

19. The streaming data processing method as recited in claim 18, wherein the step of reformatting the key frame and all packets thereafter further comprises:
updating information relating to the payload length in the header field;
counting the number of the packets that have been determined;
determining whether the number of the packets that have been counted is equal to the number of the packets that have been determined; and
inquiring the next packet if the number of the packets that have been counted is not equal to the number of the packets that have been determined.

20. The streaming data processing method as recited in claim 12, wherein the streaming data processing method further comprises discarding the packet and inquiring the next packet if the packet is not the key frame.
